(19) United States
(12) Patent Application Publication
(10) Pub. No.: US 2020/0193402 A1
(43) Pub. Date: Jun. 18, 2020

(54) USER INTERFACE ENFORCING DEVICE CONSTRAINTS DURING PHYSICAL AND ELECTRONIC RECONCILIATION

(71) Applicant: Target Brands, Inc., Minneapolis, MN (US)

(72) Inventor: Patrick Michael Egan, Mendota Heights, MN (US)

(21) Appl. No.: 16/219,425

(22) Filed: Dec. 13, 2018

(51) Int. Cl. G06Q 20/20; G06Q 10/06; G07D 11/24; G07D 11/23; G06F 17/24

(52) U.S. Cl. CPC G06Q 20/20; G06Q 10/063; G06F 17/243; G07D 11/23; G07D 11/24

(57) ABSTRACT

A computer-implemented method includes generating a computer user interface to accept physical counts of items associated with events recorded by a collection of electronic devices. A first user interface screen includes a list of a first subset of electronic devices from the collection of electronic devices and for each electronic device in the first subset, a field indicating a physical count of items associated with the electronic device. A second user interface screen includes input fields for receiving physical counts of the items and a menu of a second subset of the collection of electronic devices, wherein none of the electronic devices in the second subset are in the first subset such that it is impossible for a user to select an electronic device displayed on the first screen.

### BACKGROUND

Electronic devices have been used to record events in complex systems. The recorded events can be used to provide an expected state of the system. However, if the device incorrectly records the event or if events that are not captured by the device occur, the physical state of the system can differ from the expected state of the system. To better align the expected state of the system with the actual physical state of the system, a reconciliation process can be invoked in which the physical state of the system is independently assessed and is compared to the expected state of the system provided by the electronic device.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method includes generating a computer user interface to accept physical counts of items associated with events recorded by a collection of electronic devices. A first user interface screen includes a list of a first subset of electronic devices from the collection of electronic devices and for each electronic device in the first subset, a field indicating a physical count of items associated with the electronic device. A second user interface screen includes input fields for receiving physical counts of the items and a menu of a second subset of the collection of electronic devices, wherein none of the electronic devices in the second subset are in the first subset such that it is impossible for a user to select an electronic device displayed on the first screen.

A computer includes a memory containing instructions and a processor executing the instructions in the memory to perform steps. The steps include requesting from a server, a list of devices that send transaction data to the server and separating the list of devices into a first set of devices and a second set of devices. A first user interface is populated with devices that are in the first set of devices but that are not in the second set of devices. A menu in a second user interface is populated with devices that are in the second set of devices but that are not in the first set of devices such that it is not possible to select a device from the first set of device in the second user interface, wherein the second user interface provides input fields for receiving counts of physical items associated with a device.

In accordance with a further embodiment, a method includes providing login credentials for a user to a server as part of a request for a location associated with the user. The location is received from the server and is provided to a second server with a request for devices associated with the location. A list of devices associated with the location is received from the second server and is used to generate user interfaces to receive values of physical items associated with each of the devices.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system in accordance with one embodiment.

FIG. 2 is a flow diagram for initiating a web application session.

FIG. 3 is a user interface of a homepage in accordance with one embodiment.

FIG. 4 is a flow diagram for start fund configuration in accordance with one embodiment.

FIG. 5 is an example user interface of a start fund page.

FIG. 6 is an example user interface of the start fund page with editable fields.

FIG. 7 is a flow diagram for setting a new sales date.

FIG. 8 is an example user interface for setting a new sales date.

FIG. 9 is a flow diagram of a method of receiving advances to select registers.

FIG. 10 is an example user interface for receiving advances previously made to a register.

FIG. 11 is a flow diagram of a method of generating a first safe balance.

FIG. 12 is a user interface for entering a count for a safe.

FIG. 13 is an example user interface showing a popup safe balance table.

FIG. 14 is a flow diagram of a method for receiving count for register bags.

FIG. 15 provides an example user interface for receiving counts for a single register bag.

FIG. 16 provides a flow diagram of a method of transferring funds to a safe.

FIG. 17 provides an example user interface used to form a count of funds transferred to a safe.

FIG. 18 provides a flow diagram of a method of receiving counts for a deposit.

FIG. 19 provides a user interface for providing counts for a deposit.

FIG. 20 provides a flow diagram of a method for receiving counts for advances for registers.

FIG. 21 provides a user interface for entering counts for an advance to a register.

FIG. 22 provides a flow diagram of a method of receiving counts for funds received from a bank.

FIG. 23 provides a user interface used to receive counts for funds received from a bank.

FIG. 24 provides a flow diagram of a method of generating a second safe balance.

FIG. 25 provides a user interface for entering counts of funds in a safe for a second safe balance.

FIG. 26 provides a user interface showing a popup window containing a safe balance table.

FIG. 27 provides a block diagram of a computing device used in the various embodiments.

### DETAILED DESCRIPTION

In complex systems such as multi-register retail stores, multiple devices record different events and transmit corresponding event information to a remote server. The transmitted event information can be used to estimate a state of the retail system, such as the amount of cash collected by each register, the amount of cash currently in the retail store, and the amount of cash deposited in a bank. However, through various human and machine errors, it is possible for the estimate developed from the electronic information to be different from the physical state of the store. As a result, it is necessary to reconcile the physical state of the store with the state estimated from the electronic data.

Within a retail store, cash moves between different parts of the store during the course of the day. For example, cash will be moved from a register on the sales floor to a register bag that is stored in a safe. Other cash will move from the safe to registers that are short on cash. Still other cash will be bundled into bank deposit bags that are then sent to the bank. Additionally, at the end of the day, registers will be pre-loaded with cash for the next day. For some registers, the amount of cash loaded into the register for the next day is fixed. For other registers, the amount can vary from day to day.

For security purposes, there are times when the same cash is counted twice. For example, cash advanced to a register on one day is counted at the time it is sent to the register and is recounted on the next day to ensure that it is still there. At other times, it is important to avoid recounting the cash in a register because it will be recorded as a double count of the same money. This creates an error-prone system in which it is easy for employees, especially new employees, to become confused as to where certain counts are to be recorded and how each register is to be treated.

Embodiments described below reduce the errors associated with counting cash in a retail environment and thereby improve the process of reconciling electronic transaction data with the actual physical state of the store's cash. In particular, the various embodiments provide user interfaces that constrain where certain registers are displayed so as to prevent double counting of cash when such double counting will create errors while allowing double counting when it will not create errors. Further, the registers provided in the user interface are identified from a list of registers maintained by a transaction server that receives transaction data from the registers. As a result, the cash count user interfaces provide the same register identifiers that are used by the transaction server, thereby removing the possibility that a cash count will be recorded against a register that is not present in a store. Thus, the various embodiments generate a computer user interface to accept physical counts of items associated with events recorded by a collection of electronic devices, which in one case are POS registers.

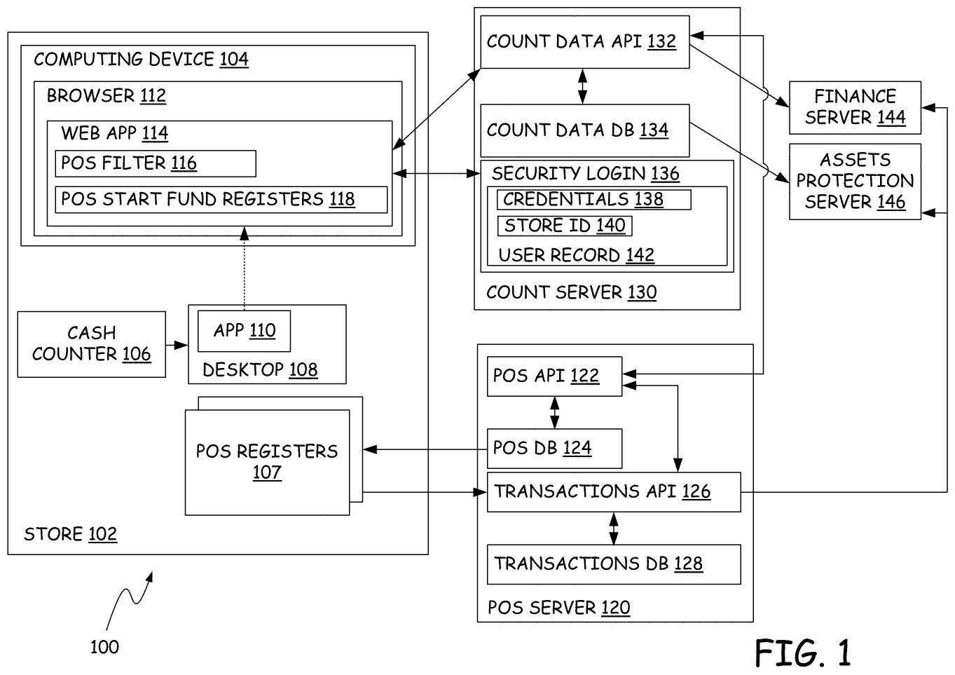

FIG. 1 provides a block diagram of a system 100 in accordance with one embodiment. System 100 includes a store 102 containing a computing device 104, a cash counter 106, a desktop device 108 running an application 110 and a collection of POS (point-of-sale) registers 107. Cash counter 106 is capable of physically counting paper currency and providing a number of items counted and/or a monetary value of the items counted to application 110 on desktop device 108. Application 110 displays the number of times counted and/or the monetary value to a user who enters the values in user interfaces generated by a web application 114 executed by a network browser 112 running on a computing device 104. In particular, web application 114 provides different user interfaces for entering counts of currency found in different locations in the store and counts of currency as it is transferred from one location to another. The user interfaces are designed to prevent unwanted double counting of currency. In addition, web application 114 reports the various counts to a count server 130 using identifiers for registers that are received from a point of sale (POS) server 120.

POS server 120 executes a POS API 122 and a transactions API 126. POS API 122 stores and retrieves data from a POS database 124 relating to the POS registers assigned to each store while transactions API 126 stores and retrieves data from a transactions database 128 that records individual transaction events performed by the POS registers.

Count server 130 executes a count data API 132 and a security login 136. Count data API 132 writes data to and reads data from a count database 134 to record cash counts from multiple different retail stores. Security login 136 controls access to web application 114 using a collection of user records 142, where each record contains at least login credentials 138 and a store identifier 140. Count data API 132 and transactions API 126 are also accessed by a finance server 144 and an assets protection server 146 as described further below.

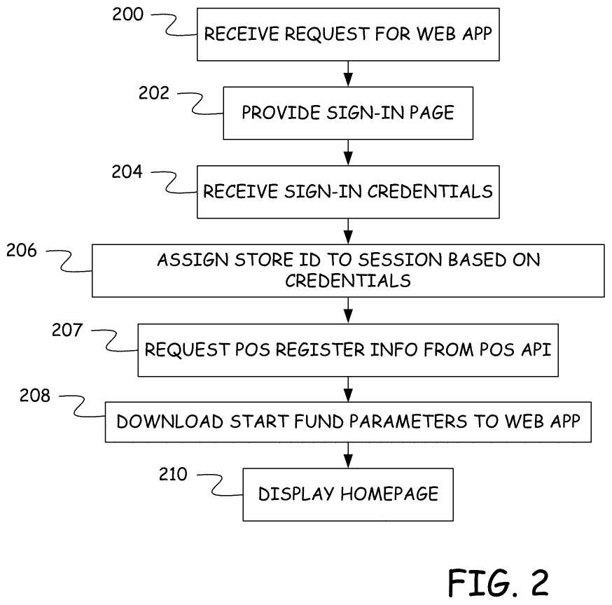

Before web application 114 can be used to record currency counts, a web browser session must be initiated between count server 130 and browser 112. To initiate the web browser session, count server 130 performs the steps shown in the flow diagram of FIG. 2. At step 200, count data API 132 on count server 130 receives a request for web application 114 from browser 112. At step 202, count server 130 provides a sign-in page to browser 112 and at step 204, security login 136 receives the sign-in credentials entered in the sign-in page by a user. Security login 136 verifies the sign-in credentials, which in accordance with one embodiment are the same credentials used to access other networks associated with a retail enterprise that operates store 102. At step 206, security login 136 assigns a store ID to the web session based on the received login credentials. In particular, the login credentials 138 are used to identify a user record 142 and the associated store ID 140 for that user record 142 is set as the store ID for the session. Thus, users are limited to providing counts for only the store that their credentials are associated with and cannot provide or access counts for other stores.

At step 207, Count Data API 132 sends a request to POS API 122 for information about all registers associated with the store identified by store ID 140 and in return receives a list of the registers and their associated register types. Count Data API 132 stores this register information so that Count Data API 132 can provide the information to web app 114 upon request. In other embodiments, web app 114 makes such requests directly to POS API 122 and Count Data API 132 does not need to store the register information.

At step 208, count server 130 downloads start fund parameters to web app 114 where they are stored as POS start fund registers 118. Start fund registers represent a class of registers that are assigned a set amount of starting funds each day to ensure that they are able to fulfill their designated purpose. For example, self-checkout registers must have adequate start funds to make change without using any cash received during the day. Similarly, customer service registers must have sufficient funds to provide refunds for returned merchandise.

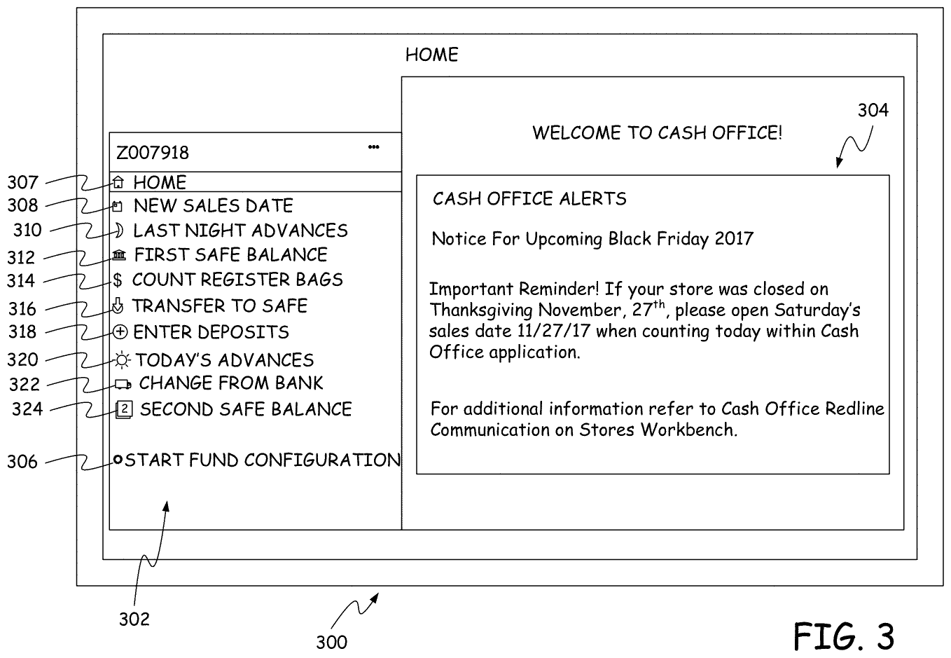

At step 210, web app 114 displays a homepage. FIG. 3 provides an example user interface 300 showing the displayed homepage. The homepage includes a page menu 302 shown along a left-side of the user interface and a messaging area 304 shown on the right side. Page menu 302 allows the user to move between different user interface pages using respective page links 306, 307, 308, 310, 312, 314, 416, 318, 320, 322, 324, and 326. Messaging area 304 provides real-time procedural updates for changes in cash counting procedures for the retail enterprise.

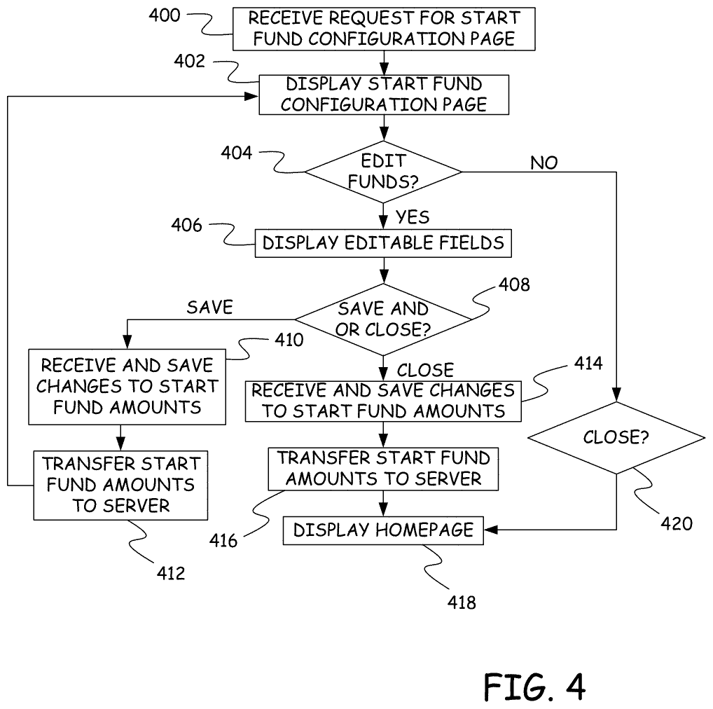

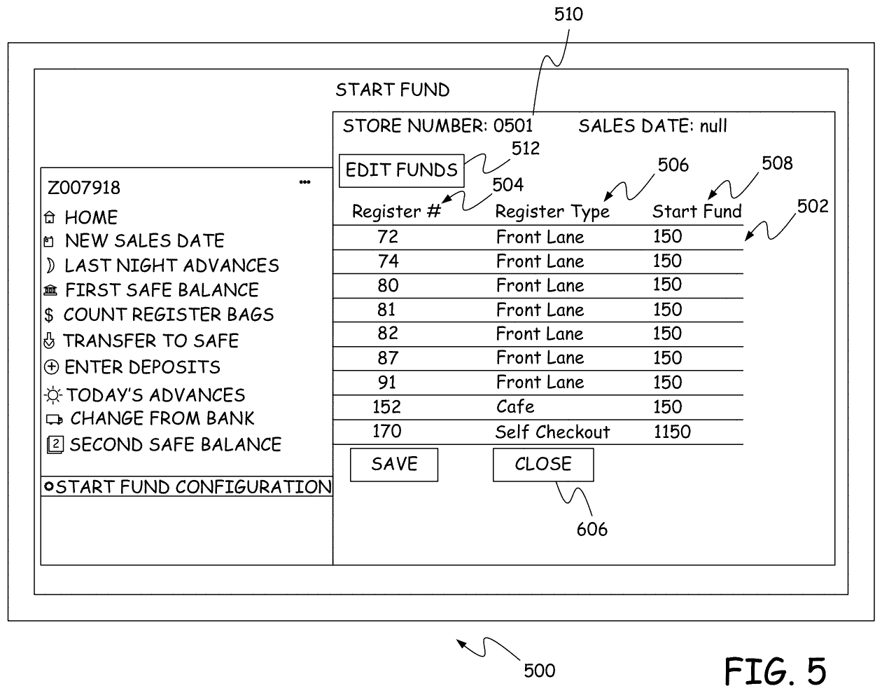

Page link 306 of page menu 302 is for a start fund configuration page. When link 306 is selected, web app 114 receives the selection as a request for a start fund configuration page in step 400 of the flow diagram of FIG. 4. In response, web app 114 displays the start fund configuration page at step 402. FIG. 5 provides an example of a start fund configuration page 500 providing a list of registers 502 that have been designated to begin the day with a set start fund amount. The list of registers includes a register number 504, a register type 506, and a start fund amount 508 for each register in the list. Start fund page 500 also includes the store number ID 510 for the store associated with the user's credentials. Thus, the register list 502 is the register list for the store identified by store ID 510 and are stored as POS start fund registers 118 of FIG. 1. In other words, user interface 500 provides a list of a first subset of electronic devices from a collection of electronic devices listed on POS server 120 for the store. For each electronic device in the first subset of electronic devices, a field indicates a physical count of items (in one case currency) associated with the electronic device.

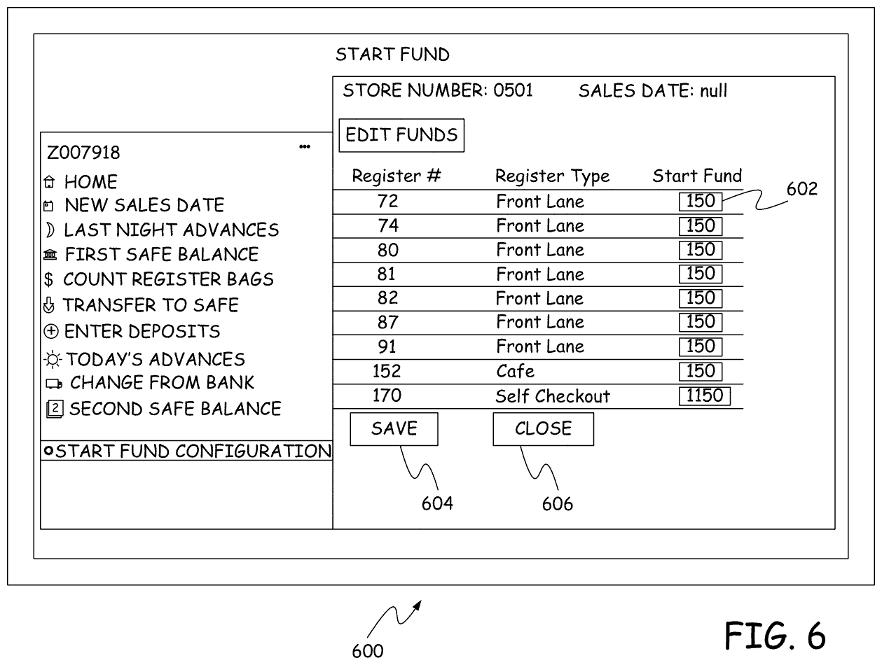

If a user wishes to change a start fund amount, they select an edit funds control 512 at step 404, which causes an editable version 600 of user interface 500 to be displayed at step 406 as shown in FIG. 6. In editable version 600, each of the start funds are shown in an editable field, such as editable field 602, which allows the user to enter a new start fund amount for each register. When the user is satisfied with the amounts, they can either select a save control 604 or a close control 606. When the user selects save control 604, the start fund values in the editable fields are received and saved by web application 114 at step 410. The start fund values are then transferred to count server 130 at step 412 so that they can be stored for the store ID and can be provided the next time web application 114 is started. After the start funds are transferred, web application 114 returns to step 402 and redisplays the start fund configuration page.

When the user selects close control 606 at step 408, the start fund values in the editable fields are received and saved by web application 114 at step 414. The start fund values are then transferred to count server 130 at step 416 so that they can be stored for the store ID and can be provided the next time web application 114 is started. After the start fund values are transferred, web application 114 displays home page 300 at step 418. The user can also cause home page 300 to be redisplayed from user interface 500 by selecting close control 606, which is detected at step 420.

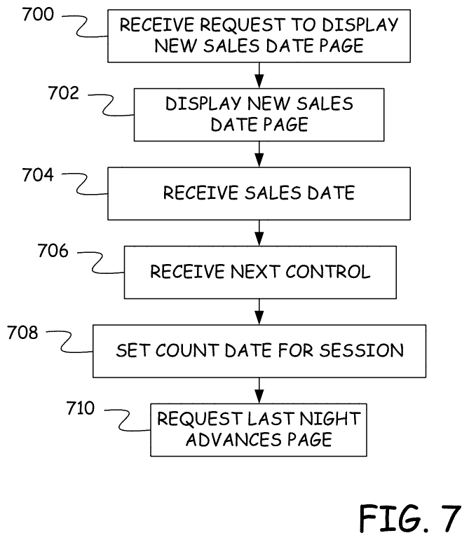

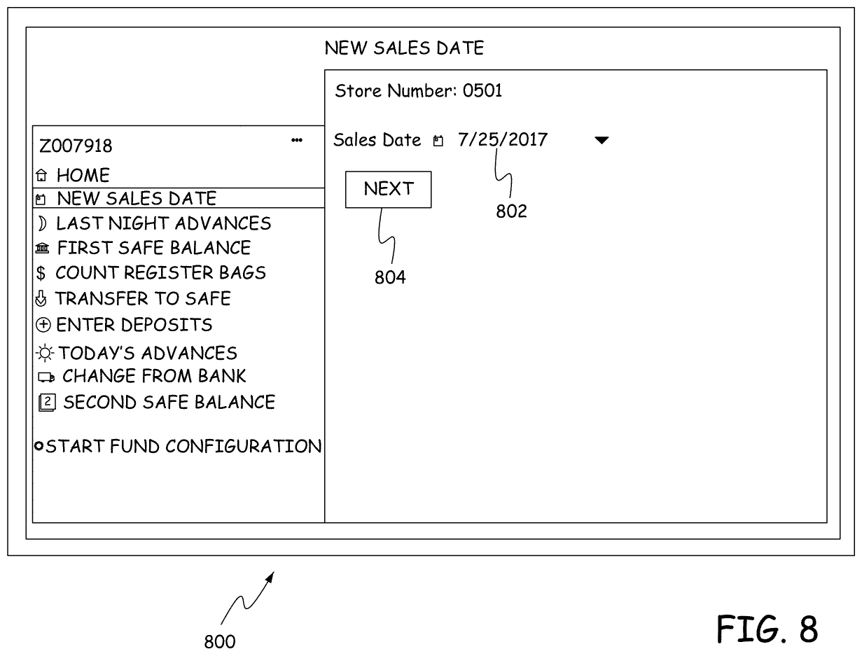

Page menu 302 also includes a new sales date link 308, which triggers the method shown in the flow diagram of FIG. 7. In step 700 of FIG. 7, the selection of link 308 is received by web app 114 as a request to display the new sales date page. At step 702, web application 114 displays the new sales date page, an example of which is shown as user interface 800 of FIG. 8. User interface 800 includes a date control 802 that can be selected by the user to set a date for which a count is to be performed. When the user has used control 802 to select a date, the sales date is received by web app 114 at step 704. The user then selects a NEXT control 804, which is received at step 706. Note that NEXT control 804 is not operable until a date has been selected so that all counts that are received can be tied to a specific date. In response to receiving the selection of the NEXT control, web app 114 sets the count date for the current web session at step 708 and requests a Last Night Advances Page at step 710.

Last night advances represent paper and coin currency set aside the previous day to provide beginning funds for a register for the next day. The last night advances are flexible and can vary from day-to-day.

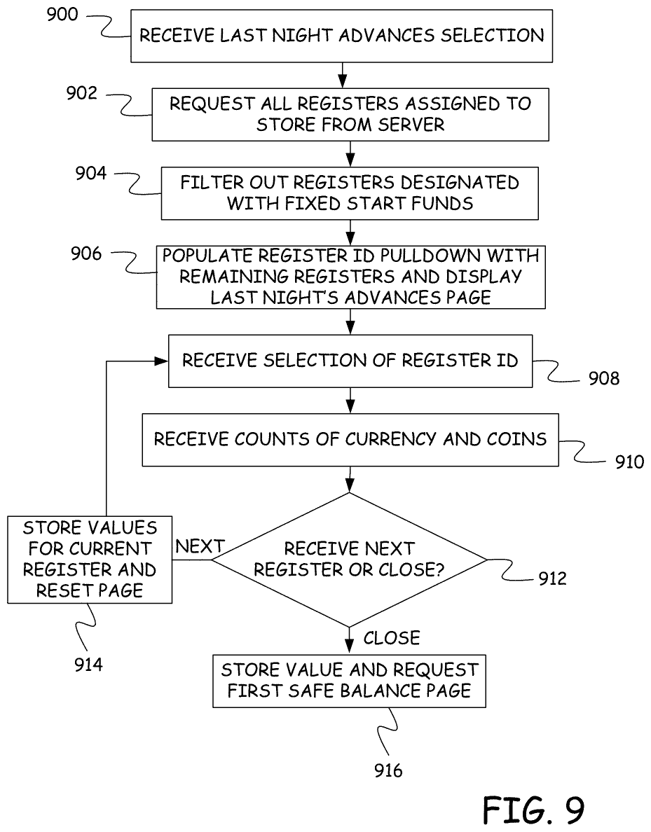

When a user selects link 310 of menu 302 or when the Last Night Advances page is requested at step 710, web app 114 receives the last night advances request at step 900 of the method of FIG. 9. In response, at step 902, web app 114 requests all registers assigned to the store from Count Data API 132. Count Data API 132 then returns the list of registers that Count Data API 132 previously requested from POS server 120. As indicated above, in some embodiments, web app 114 requests the lists of registers directly from POS server 120. At step 904, web app 114 uses POS filter 116 to filter out registers designated as having fixed start funds as listed in POS start fund registers 118. This filtering separating the list of devices from POS server 120 into a first set of devices and a second set of devices.

The registers designated with fixed start funds are filtered out of the list of registers at step 904 to avoid double counting of the starting funds. In particular, registers that have been designated as containing fixed start funds are always loaded with the same amount of start funds as designated in the start fund configuration page. As such, the software automatically takes those funds into account when determining the cash balance of the safe. If those funds were also allowed to be counted as last night advances, they would be double counted thereby producing an error. By automatically filtering out registers with fixed start funds at step 904, the various embodiments remove errors that sometimes occurred when using older software systems or when recording register counts by hand.

At step 906, web app 114 populates a register ID pulldown menu with the remaining registers that were not filtered out at step 904 and displays the last night advances page.

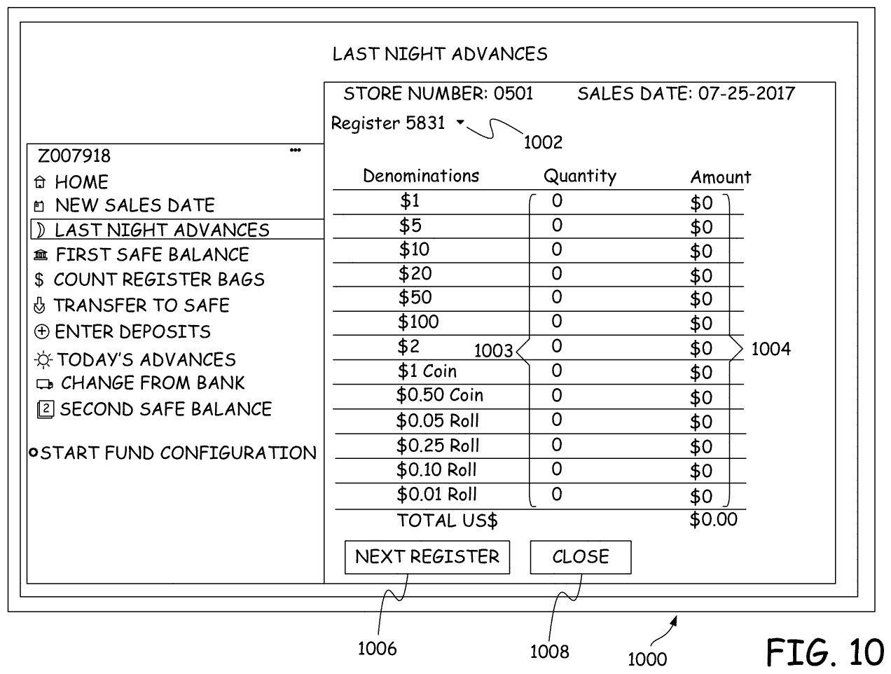

FIG. 10 provides an example user interface 1000 showing a last night advances page including a pulldown control 1002 that when selected provides the menu of register IDs populated in step 906. User interface 1000 also includes input fields 1003 for receiving physical counts of the items (in one embodiment currency). The menu of register IDs are a second subset of the collection of electronic devices provided by POS server 120. None of the electronic devices in this second subset of the collection of electronic devices are in the first subset of electronic devices displayed in user interface 500 and as such it is impossible for a user to select an electronic device displayed in user interface 500 from the menu of electronic devices in suer interface 1000.

At step 908, web app 114 receives a selection of a register ID using the menu exposed through register control 1002 and at step 910 receives either counts in input fields 1003 or monetary values in input fields 1004 for various currency denominations and coin values on user interface 1000. If a count is input in a field 1003, web app 114 calculates the corresponding monetary value and inserts the monetary value in the corresponding value input field 1004. If a monetary value is provided in an input field 1004, web app 114 calculates the corresponding count and inserts it into a corresponding count field 1003.

When the user selects a next register control 1006 at step 912, web app 114 stores the currency and coin values for the current register ID and resets user interface 1000 at step 914 so that all of the input field values are set to zero and the register ID is no longer shown next to register control 1002. Steps 908 and 910 are then repeated to allow the user to select another register and to enter the currency and coin values for last night advances for that register. When all of the registers have been processed, the user selects close control 1008 at step 912 and the values for the last register are stored and a First Safe Balance page is requested at step 916.

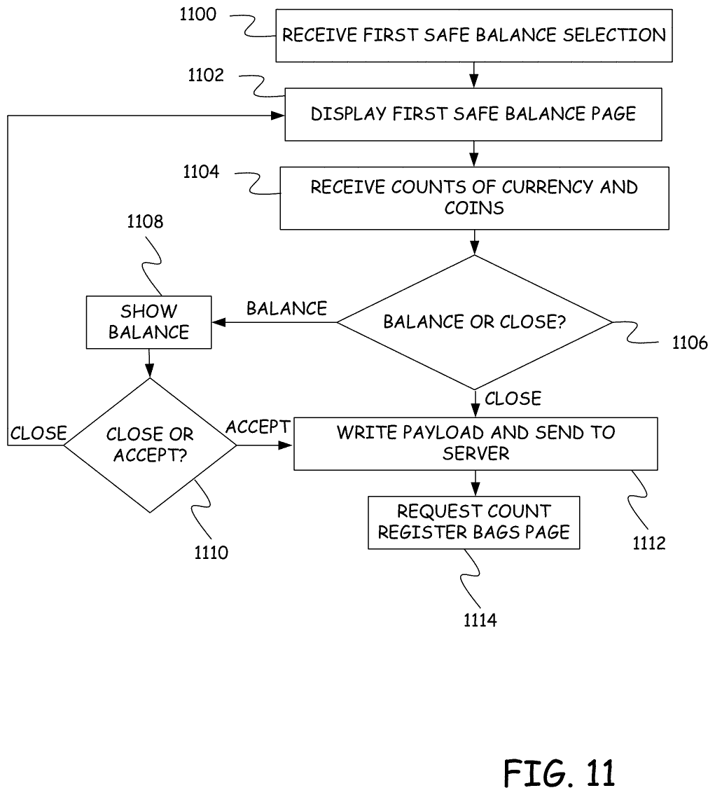

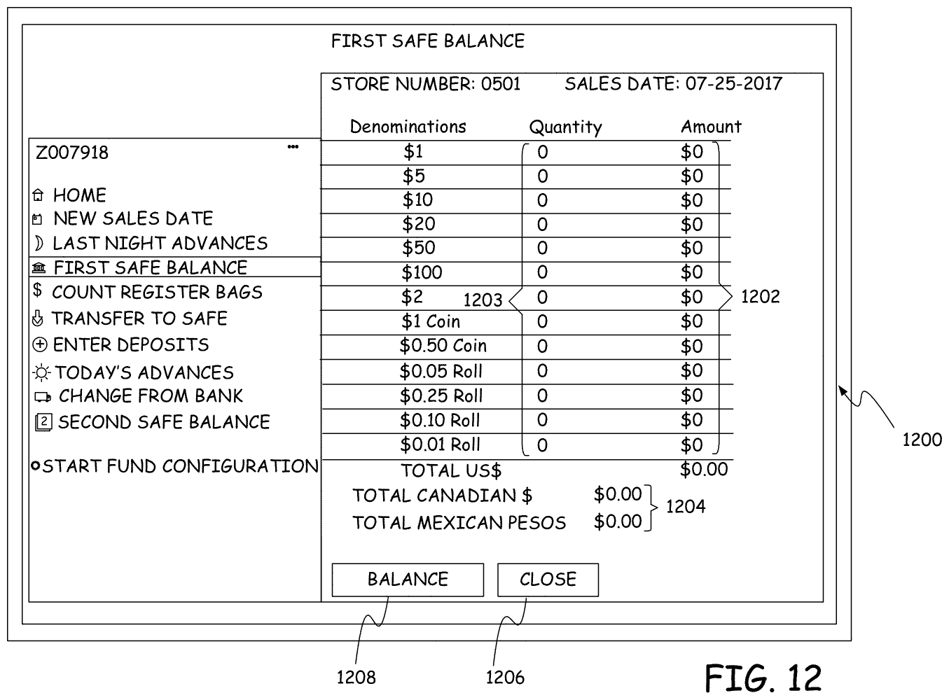

The First Safe Balance page is used to upload counts of paper currency and coins found in the safe. When the First Safe Balance page is requested at step 916 or when First Safe Balance link 312 of menu 302 is selected, the process of FIG. 11 begins at step 1100 where web app 114 receives the first safe balance request. At step 1102, web app 114 displays the first safe balance page. User interface 1200 of FIG. 12 provides an example of a first safe balance page, which includes a set of count input fields 1203 and a set of monetary value fields 1202 for various currency denominations and coin values. In addition, total monetary value input fields 1204 are provided for various foreign currencies, such as Canadian Dollars and Mexican Pesos.

At step 1104 of FIG. 11, web app 114 receives either counts in input fields 1203 or monetary values in input fields 1202 for the various currency denominations and coin values on user interface 1200. If a count is input in a field 1203, web app 114 calculates the corresponding monetary value and inserts the monetary value in the corresponding value input field 1202. If a monetary value is provided in an input field 1202, web app 114 calculates the corresponding count and inserts it into a corresponding count field 1203.

When web app 114 determines that a close control 1206 has been selected at step 1106, web app 114 writes the last night advances counts for each of the registers, the fixed start fund amount for the fixed start fund registers and the first safe balance to as a payload at step 1112. Web app 114 then sends the payload to count data API 132 of count server 130. In accordance with one embodiment, the payload is written in a JSON format that has a separate entry for each denomination, where each entry includes the count for that denomination, the credentials of the user, the store ID, and the count date. After the payload has been sent to count server 130, web app 114 requests a Count Register Bags page at step 1114.

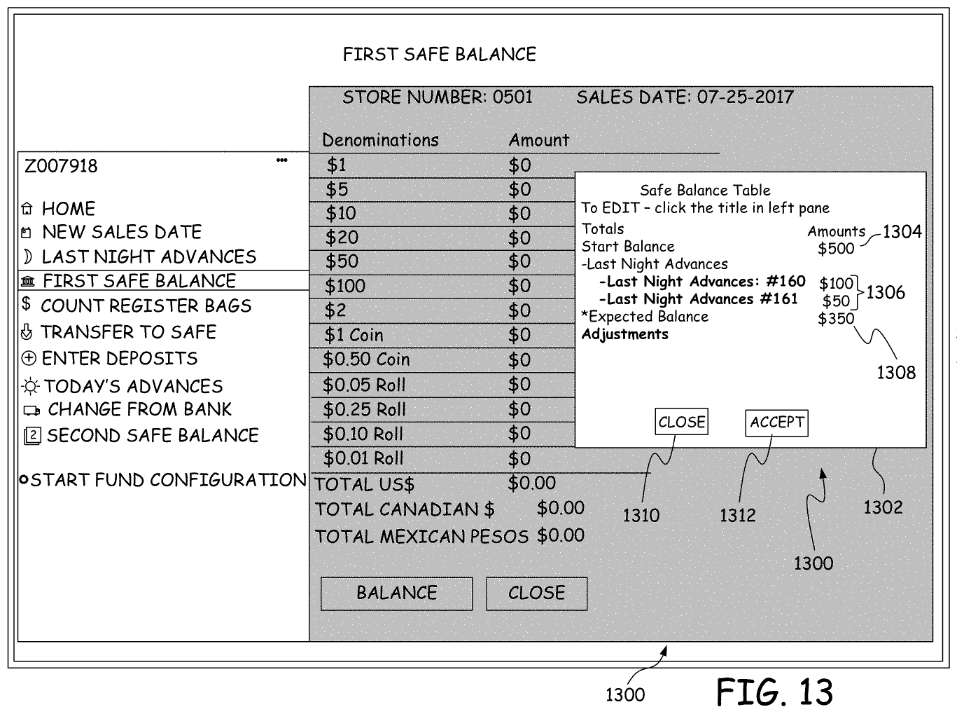

In accordance with some embodiments, an additional balance control 1208 is displayed in user interface 1200. When a user selects balance control 1208 at step 1106, a safe balance is shown at step 1108 based on the counts entered in user interface 1200 and the counts entered in user interface 1000. User interface 1300 of FIG. 13 shows an example of a balance popup window 1302 showing a previous balance 1304, a collection of last night advances 1306 and an expected current balance 1308. The last night advances 1306 are a list of last night advances for each register for which a last night advance has been entered.

The user is able to compare the current balance 1308 to the amount the user has entered in first safe balance page 1200. If the balances do not match, the user can select close control 1310 at step 1110, which causes the process to return to step 1102 to display the first safe balance page 1200 once again. This will allow the user to recount the paper currency and coins in the safe and enter corrected values. Additionally, the user can recount the last night advances by selecting link 310 and re-entering the values for one or more registers for the last night advances.

When the user presses an accept control 1312 in popup window 1302 at step 1110, web app 114 executes steps 1112 and 1114 as discussed above.

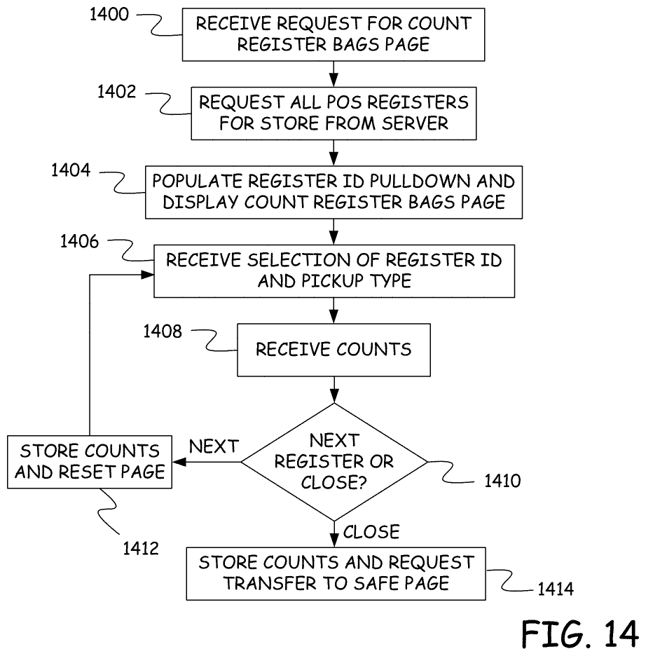

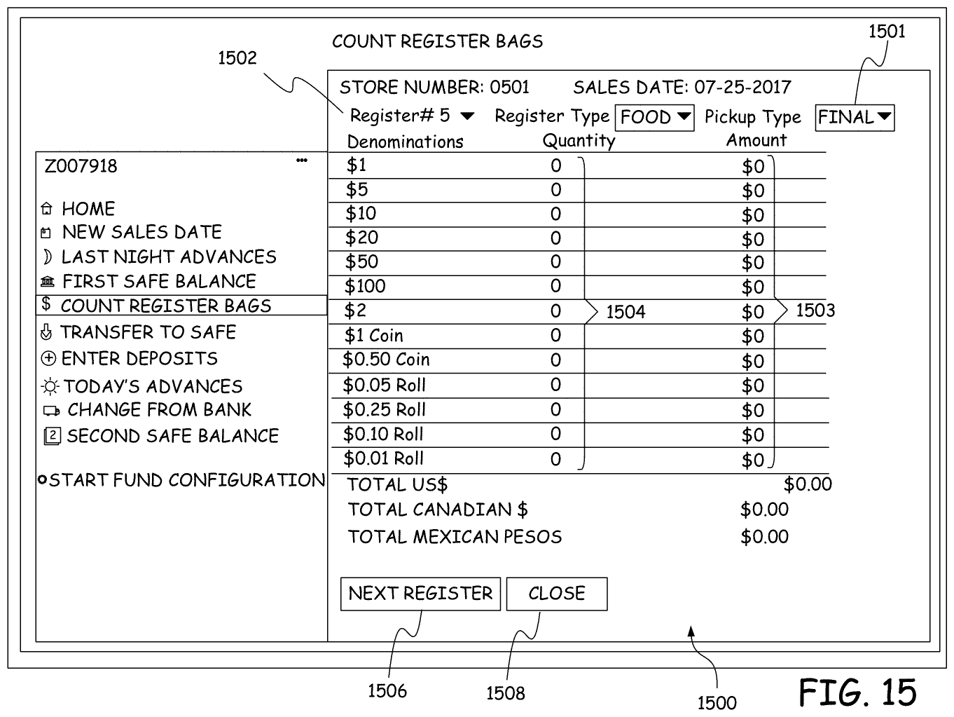

The Count Register Bags page allows a user to enter counts for currency denominations found in bags containing money collected from each of the registers. The Count Register Bags page is requested either at step 1114 or by a user selecting Count Register Bags link 314 in page menu 302. At step 1400 of FIG. 14, web app 114 receives the request for the Count Register Bags page and in response at step 1402 requests all POS registers for the store from Count Data API 132. In response, Count Data API 132 retrieves the registers previously received from POS server 120 and returns the register IDs to web app 114. The retrieved POS IDs are the same POS IDs used by transactions API 126 to authenticate and organize transactions received from POS registers 107. Thus, there is a single common source for the list of register IDs associated with a store that is used by transactions API 126, web app 114 and count data API 132. This allows the transactions recorded by transactions API 126 to be linked to the currency counts generated by web app 114 and count data API 132 thereby providing a more secure system for reconciling the electronic data records generated by POS registers 107 and the physical count of cash in store 102. At step 1404, web app 114 populates a register ID pulldown menu with the register IDs returned at step 1402 and displays a Count Register Bags user interface 1500 shown in FIG. 15.

At step 1406, web app 114 receives a selection of a register ID through pulldown control 1502 of user interface 1500 and a selection of Pickup Type through a pulldown control 1501 of user interface 1500. Register Bags can be filled several times during a day. Each bag that is filled for a single register is designated with a different Pickup Type. In accordance with one embodiment, the list of possible Pickup Types includes Pickup 1, Pickup 2, Pickup 3 and Final. Thus, a register bag is identified by the combination of the Register Id and the Pickup Type. and at step 1408, receives either counts in input fields 1504 or monetary values in input fields 1503 for various currency denominations and coin values on user interface 1500. If a count is input in a field 1504, web app 114 calculates the corresponding monetary value and inserts the monetary value in the corresponding value input field 1503. If a monetary value is provided in an input field 1503, web app 114 calculates the corresponding count and inserts it into a corresponding count field 1504.

At step 1410, web app 114 determines if the user has selected next register control 1506. When next register control 1506 is selected, the received count values are stored for the selected register and pickup type and the page is reset at step 1412 by setting all input fields to zero and removing the selected register ID displayed next to pulldown control 1502. The process then returns to step 1406 to receive the selection of a new register and/or a new pickup type. When web app 114 determines that the user has selected close control 1508 of user interface 1500 at step 1410, web app 114 stores the counts for the selected register and pickup type and requests a Transfer to Safe page at step 1414.

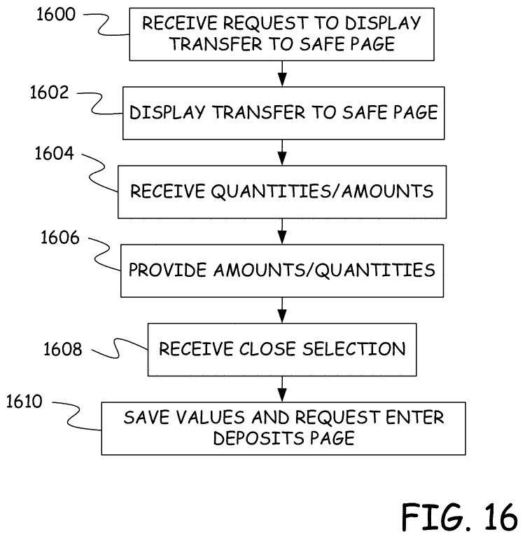

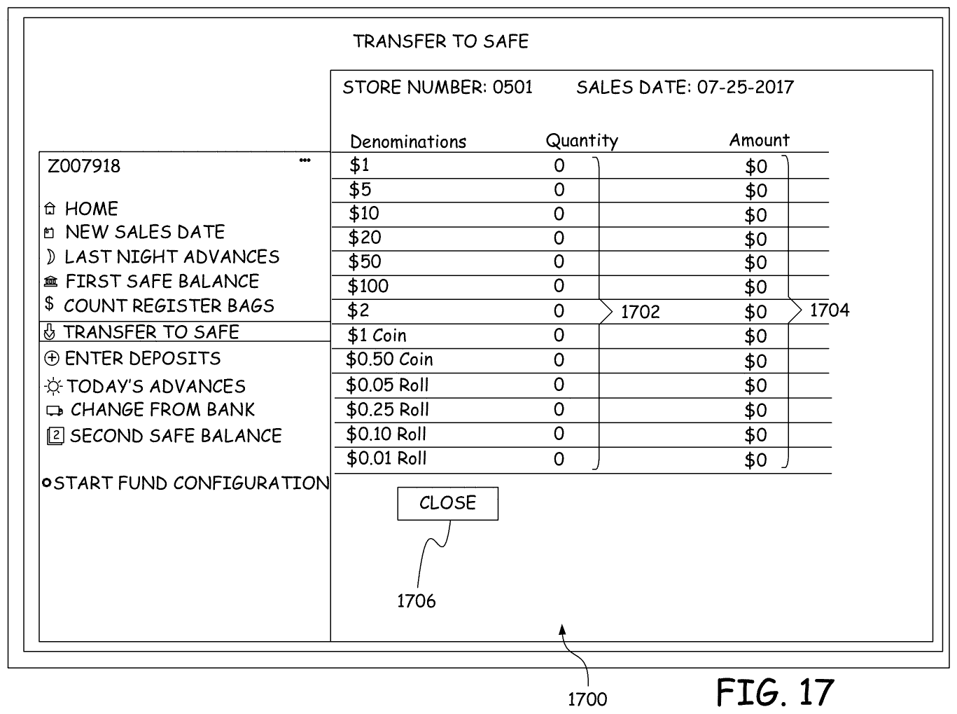

The Transfer to Safe page allows a user to assign cash to the safe that had previously been in the register bags. The Transfer to Safe page is requested at step 1414 or by a user selecting Transfer to Safe link 316. The request to display the Transfer to Safe page is received at step 1600 of FIG. 16. In response, at step 1602, web app 114 displays the Transfer to Safe page, such as Transfer to Safe page 1700 of FIG. 17. Transfer to Safe page 1700 includes a set of quantity entries 1702 for each of a set of paper and coin denominations as well as a set of amount input fields 1704 for receiving a value of the paper and coin denominations. At step 1604, web app 114 receives inputs in one or more of the quantity input fields 1702 and/or one or more of the amount input fields 1704. At step 1606, if a quantity is input in a field 1702, web app 114 calculates the corresponding monetary value and inserts the monetary value in the corresponding value input field 1704. If a monetary value is provided in an input field 1704, web app 114 calculates the corresponding count and inserts it into a corresponding quantity field 1702. web app 114 provides the corresponding amount for quantities in the corresponding input field for a given value provided in a quantity or amount input field. At step 1608, web app 114 receives an indication that close control 1706 has been selected and in response stores the values provided in Transfer to Safe page 1700 and requests an Enter Deposits page at step 1610.

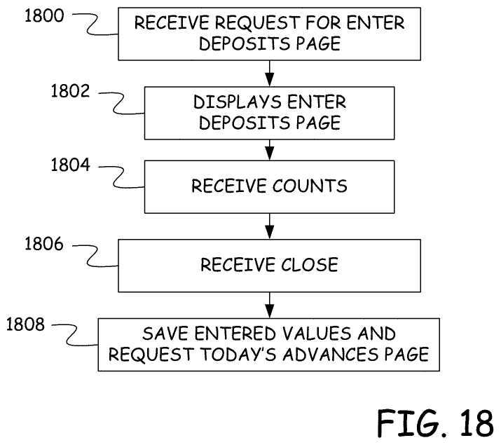

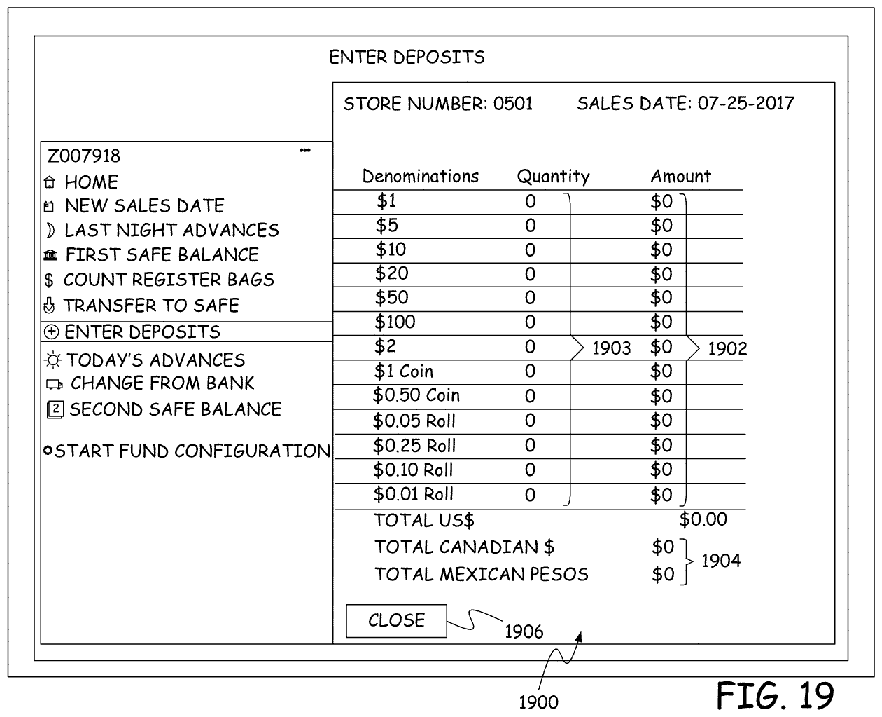

The Enter Deposits page allows the user to enter counts of currency that is being sent to a bank for deposit. The Enter Deposits page can be requested either at step 1610 or by a user selecting Enter Deposits link 318. At step 1800 of FIG. 18, web app 114 receives the request for the Enter Deposits page and at step 1802, web app 114 displays the Enter Deposits page, an example of which is shown as user interface 1900 of FIG. 19.

Enter Deposits page 1900 includes a set of count input fields 1903 and a set of monetary value fields 1902 for various currency denominations and coin values. In addition, total monetary value input fields 1904 are provided for various foreign currencies, such as Canadian Dollars and Mexican Pesos. At step 1804, web app 114 receives either counts in input fields 1903 or monetary values in input fields 1902 for the various currency denominations and coin values on user interface 1900 and if applicable the total values of various foreign currencies in input fields 1904. If a count is input in a count field 1903, web app 114 calculates the corresponding monetary value and inserts the monetary value in the corresponding value input field 1902. If a monetary value is provided in an input field 1902, web app 114 calculates the corresponding count and inserts it into a corresponding count field 1903.

At step 1806, web app 114 receives a selection of close button 1906. In response, the received counts are saved and a Today's Advances page is requested at step 1808.

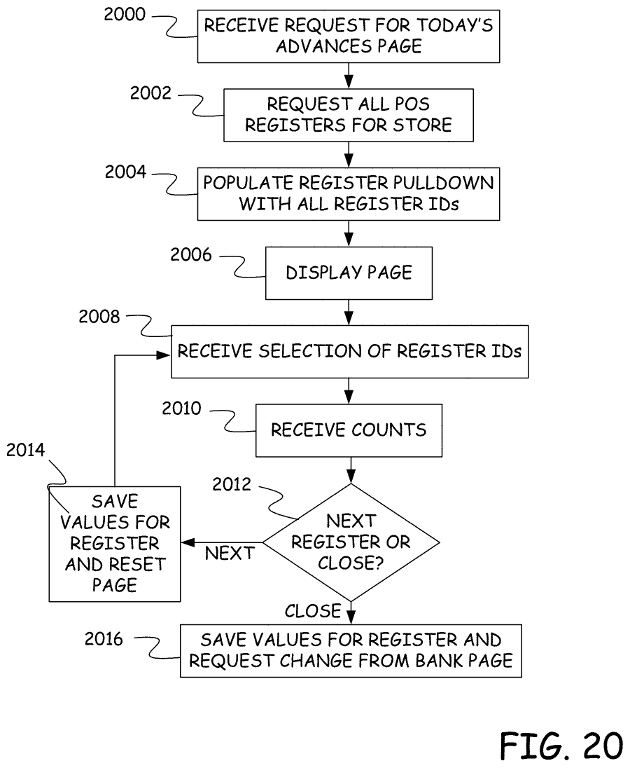

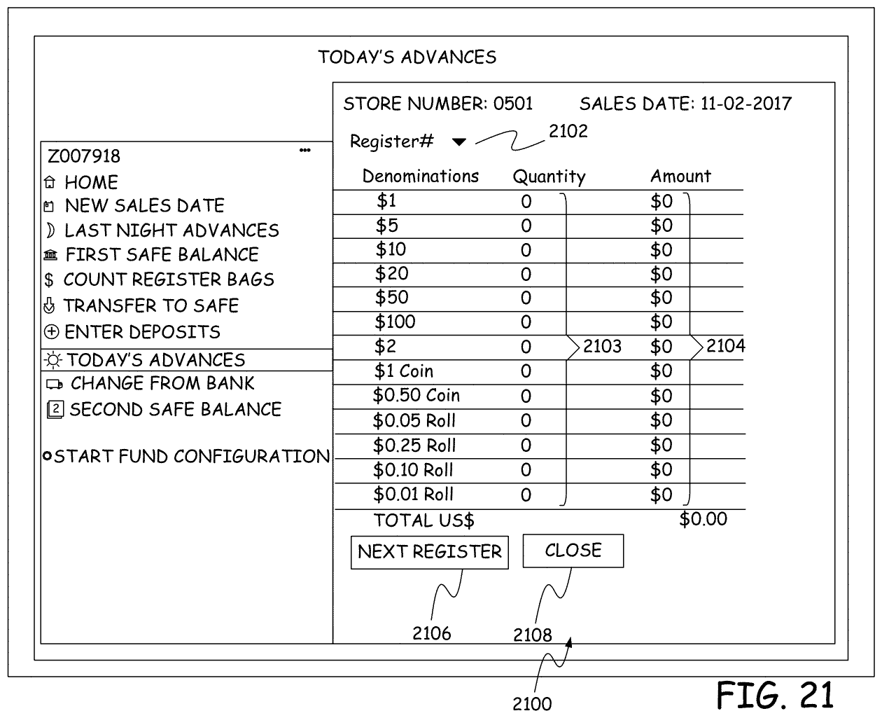

The Today's Advances page allows a user into provide counts for money transferred from the safe to a register during the day. The Today's Advances page can be requested either at step 1808 or by using Today's Advances link 320 of page menu 302. At step 2000 of FIG. 20, a request for the Today's Advances page is received. At step 2002, web app 114 requests all POS registers for the store from Count Data API 132 and populates a register pulldown menu with all of the returned register IDs at step 2004. At step 2006, web app 114 displays the Today's Advances page, an example of which is shown as user interface 2100 in FIG. 21. Today's Advances page 2100 includes register ID pulldown control 2102, which when activated provides the list of register IDs for the store. At step 2008, web app 114 receives the selection of a register ID from the menu of register IDs. At step 2010, web app 114 receives either counts in input fields 2103 or monetary values in input fields 2104 for the various currency denominations and coin values on user interface 2100. If a count is input in a field 2103, web app 114 calculates the corresponding monetary value and inserts the monetary value in the corresponding value input field 2104. If a monetary value is provided in an input field 2104, web app 114 calculates the corresponding count and inserts it into a corresponding count field 2103.

At step 2012, web app 114 determines if a next register control 2106 has been selected. When next register control 2106 is selected, web app 114 saves the values input in input fields 2103 and 2104 at step 2014 and resets Today's Advances page 2100 to remove all values from the input fields 2103 and 2104 and to clear the register ID shown next to register pulldown control 2102. Web app 114 then returns to step 2008 to await selection of a new register ID.

When web app 114 detects that a close control 2108 has been selected at step 2012, web app 114 saves the input values for the current register and requests a Change from Bank page at step 2016.

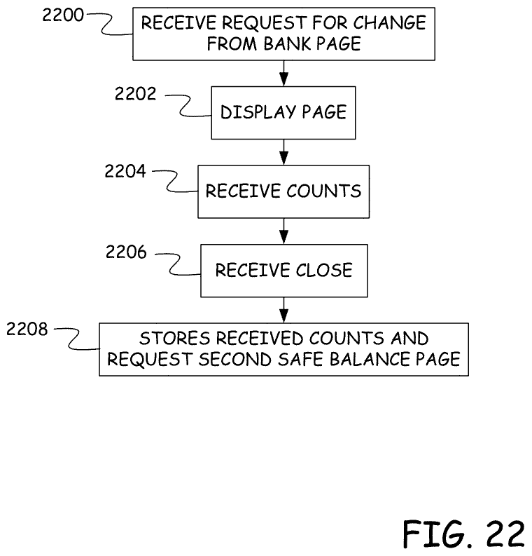

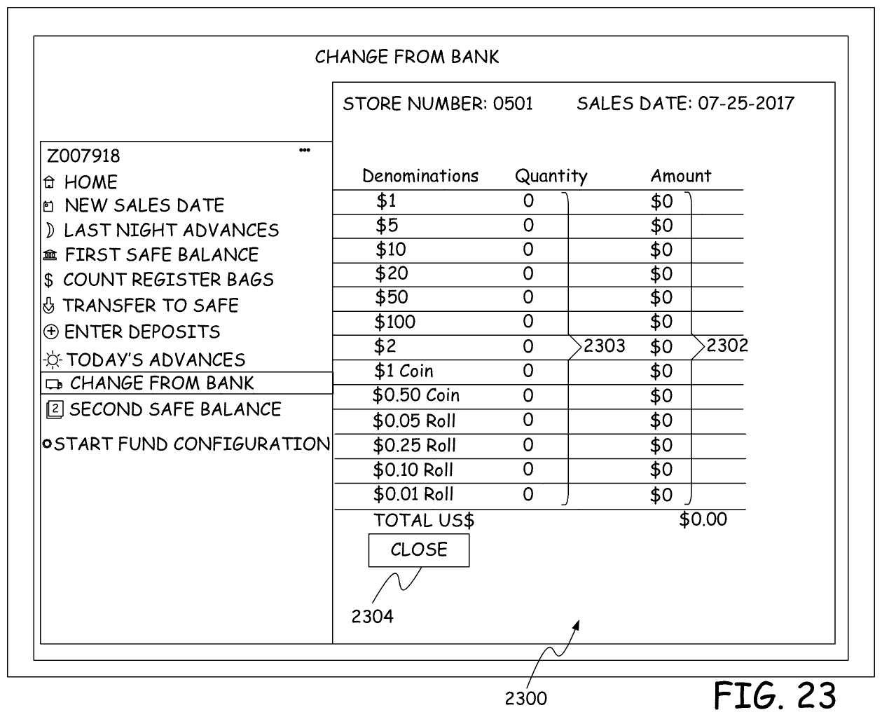

The Change from Bank page allows a user to enter counts of paper currencies and coins received from a bank. The Change from Bank page can be requested either at step 2016 or by using Change from Bank link 322 of page menu 302. At step 2200 of FIG. 22, a request for the Change from Bank page is received by web app 114. At step 2202, web app 114 displays the Change from Bank page, an example of which is shown as user interface 2300 in FIG. 23. User interface 2300 includes a set of value input fields 2302 for entering the monetary value of various denominations of paper currency and coins received from the bank and a set of quantity or count input fields 2303 for entering the count of various denominations of paper currency and coins received from the bank. At step 2204, web app 114 receives either counts in input fields 2303 or monetary values in input fields 2302 for the various currency denominations and coin values on user interface 2300. If a count is input in a field 2303, web app 114 calculates the corresponding monetary value and inserts the monetary value in the corresponding value input field 2302. If a monetary value is provided in an input field 2302, web app 114 calculates the corresponding count and inserts it into a corresponding count field 2303.

At step 2206, web application 114 receives a selection of close control 2304. In response, web app 114 stores the received inputs and requests a Second Safe Balance page at step 2208.

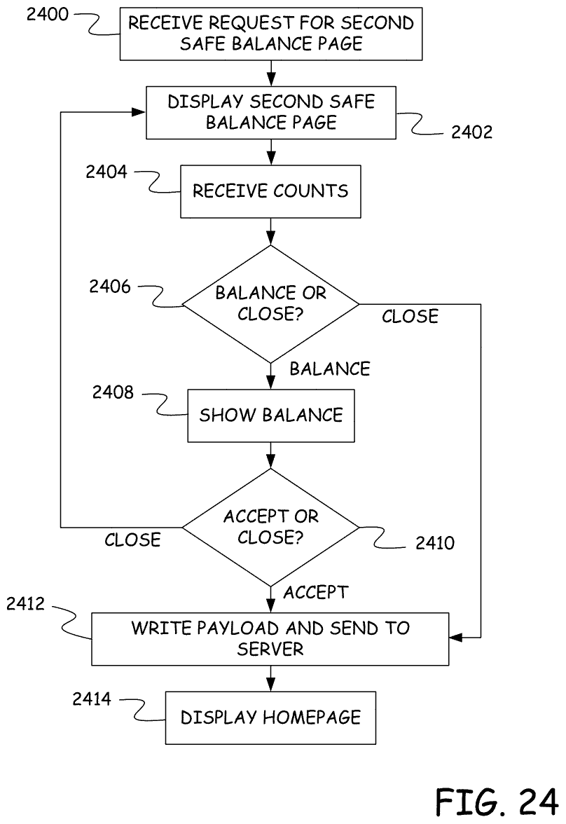

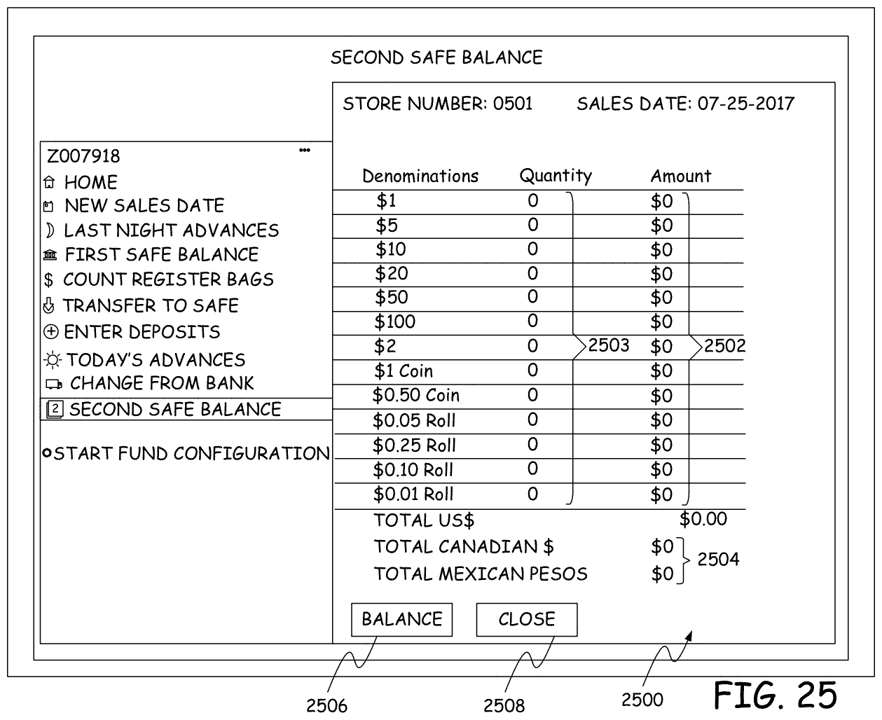

The Second Safe Balance page is used to record an end of day count of currency in the safe and can be requested either at step 2208 or by using link 324 of page menu 302. At step 2400 of FIG. 24, web app 114 receives the request for the Second Safe Balance page. At step 2402, web app 114 displays the Second Safe Balance page. User interface 2500 of FIG. 25 provides an example of a Second Safe Balance page, which includes a set of count input fields 2503 and a set of monetary value fields 2502 for various paper currency denominations and coin values. In addition, total monetary value input fields 2504 are provided for various foreign currencies, such as Canadian Dollars and Mexican Pesos.

At step 2404 of FIG. 24, web app 114 receives either counts in input fields 2503 or monetary values in input fields 2502 for the various currency denominations and coin values on user interface 2500. If a count is input in a field 2503, web app 114 calculates the corresponding monetary value and inserts the monetary value in the corresponding value input field 2502. If a monetary value is provided in an input field 2502, web app 114 calculates the corresponding count and inserts it into a corresponding count field 2503.

When web app 114 determines that a close control 2508 has been selected at step 2406, web app 114 writes the transfers to safe, the deposits, today's advances, change from the bank and the second safe balance as a payload at step 2412. Web app 114 then sends the payload to Count Data API 132 of count server 130. In accordance with one embodiment, the payload is written in a JSON format that has a separate entry for each denomination, where each entry includes the count for that denomination, the credentials of the user, the store ID, and the count date. After the payload has been sent to count server 130, web app 114 redisplays homepage 300 at step 2414.

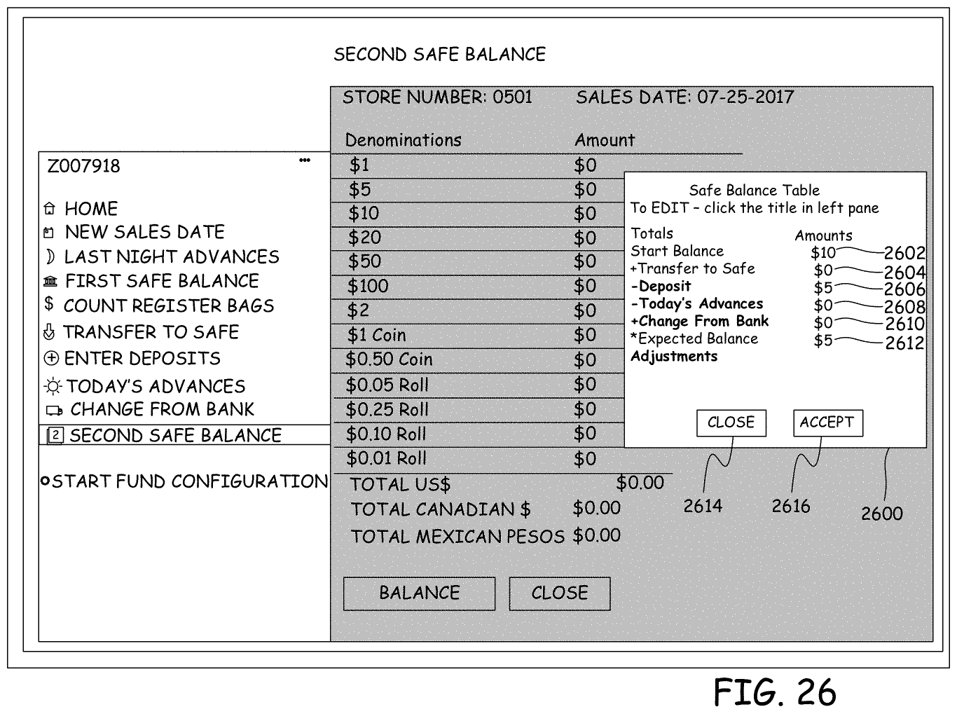

In accordance with some embodiments, an additional balance control 2506 is displayed in user interface 2500. When a user selects balance control 2506 at step 2406, a safe balance is shown at step 2408 based on the counts entered in user interfaces 1700, 1900, 2100, 2300, and 2500. User interface 2600 of FIG. 26 shows an example of a balance popup window 2601 showing a start balance 2602, a transfer to safe amount 2604, a deposit amount 2606, a today's advances amount 2608, a change from bank amount 2610 and an expected balance 2612.

The user is able to compare the expected balance 2612 to the amount the user has entered in second safe balance screen 2500. If the balances do not match, the user can select close control 2614 at step 2410, which causes the process to return to step 2402 to display second safe balance page 2500 once again. This will allow the user to recount the paper currency and coins in the safe and enter corrected values. When the user presses an accept control 2616 in popup window 2601 at step 2410, web app 114 executes steps 2412 and 2414 as discussed above.

In accordance with one embodiment, count data API 132 includes aggregating functions that aggregate the counts generated for separate registers into a single value representing the total amount of currency from all registers in a store. In addition, Count Data API 132 aggregates Register Bag counts that have a same register ID but different pickup types to provide a single Register Bag count for the register. Count data API 132 provides this aggregate data to a finance server 144 upon request from the finance server 144. Count data API 132 can provide register level count data to assets protection server 146 upon request from assets protection server 146. Because web app 114 uses the same register IDs provided by POS API 122 as transactions API 126 uses, assets protection server 146 is able to resolve discrepancies between the cash counts for particular registers and the transactions recorded by transactions API 126.

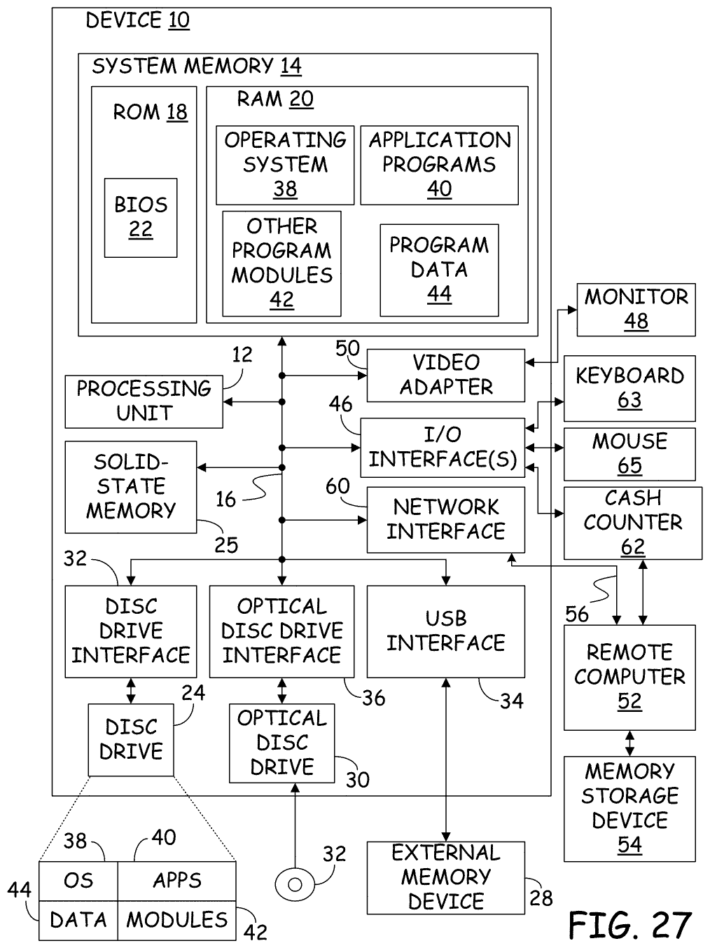

FIG. 27 provides an example of a computing device 10 that can be used as any of computing device 104, desktop 108, count server 130, pos server 120, assets protection server 146, and finance server 144. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes an optional hard disc drive 24, an optional external memory device 28, and an optional optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of modules discussed above. Program data 44 may include any data used by the systems and methods discussed above.

Processing unit 12, also referred to as a processor, executes programs in system memory 14 and solid state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 27. The network connections depicted in FIG. 27 include a local area network (LAN) or wide area network(WAN) 56. Such network environments are commonplace in the art. The computing device 10 is connected to the network through a network interface 60.

The computing device 10 is also connected to a cash counter 62 via I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 27 are exemplary and other means for establishing a communications link between the computers, such as a wireless interface communications link, may be used.

In other embodiments, web application 114 is executed on a simplified computing device that includes only a processor, a memory, a display driver and a display. In such embodiment, the processor executes browser 112, which downloads web app 114.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
generating a computer user interface to accept physical counts of items associated with events recorded by a collection of electronic devices, the computer user interface comprising:
a first user interface screen comprising:
a list of a first subset of electronic devices from the collection of electronic devices; and
for each electronic device in the first subset of electronic devices, a field indicating a physical count of items associated with the electronic device;
a second user interface screen comprising:
input fields for receiving physical counts of the items; and
a menu of electronic devices comprising a second subset of the collection of electronic devices, wherein none of the electronic devices in the second subset of the collection are in the first subset of the collection such that it is impossible for a user to select an electronic device displayed on the first screen and wherein selection of an electronic device from the menu designates the physical counts in the input fields as being associated with the selected electronic device.

2. The computer-implemented method of claim 1 wherein the field of the first screen indicates a set physical count of items that is found in the associated electronic device each day.

3. The computer-implemented method of claim 2 wherein the input fields in the second user interface indicates a physical count of items that can change from day to day.

4. The computer-implemented method of claim 1 wherein generating the user interface comprises requesting the collection of electronic devices from a server associated with electronically recording the events that occur on the electronic devices.

5. The computer-implemented method of claim 4 wherein the input fields of the second user interface comprise a physical count of items associated with the electronic device before events occur for a day.

6. The computer-implemented method of claim 5 wherein the field indicating a physical count of items associated with the electronic device comprises a physical count of items associated with the electronic device before events occur for a day.

7. The computer-implemented method of claim 1 wherein the user interface further comprises:
a third user interface screen comprising:
input fields for receiving physical counts of the items; and
a menu of electronic devices comprising the entire collection of electronic devices, wherein selection of an electronic device from the menu designates the physical counts in the input fields as being associated with the selected electronic device.

8. A computer comprising:
a memory containing instructions;
a processor executing the instructions in the memory to perform steps comprising:
requesting from a server, a list of devices that send transaction data to the server;
separating the list of devices into a first set of devices and a second set of devices;
populating a first user interface with devices that are in the first set of devices but that are not in the second set of devices; and
populating a menu in a second user interface with devices that are in the second set of devices but that are not in the first set of devices such that it is not possible to select a device from the first set of device in the second user interface, wherein the second user interface provides input fields for receiving counts of physical items associated with a device.

9. The computer of claim 8 wherein the counts of physical items in the second user interface comprises counts of items before the device performs a first transaction for a day.

10. The computer of claim 9 wherein populating the first user interface with devices comprises populating the first user interface with a value of items found in each device in the first set of devices.

11. The computer of claim 8 further comprising receiving values in the input fields of the second user interface for at least two of the devices in the second set of devices and transmitting the values and identities of the at least two of the devices in the second set of devices to a server.

12. The computer of claim 8 further comprising:
receiving security credentials for a user;
sending the security credentials to a server;
receiving a location from the server based on the security credentials;
wherein requesting from the server the list of devices comprises requesting devices at the location.

13. The computer of claim 8 wherein the processor performs further steps comprising:
populating a menu in a third user interface with all devices in the list of devices, such that one of the devices in the list of devices can be selected, wherein the third user interface provides input fields for receiving values of physical items associated with the selected device.

14. The computer of claim 13 wherein the third user interface comprises a control that when selected stores the values of the physical items associated with the selected device, resets the values in the input fields and indicates that no device is currently selected.

15. A method comprising:
providing login credentials for a user to a server as part of a request for a location associated with the user;
receiving the location from the server;
providing the location to a second server with a request for devices associated with the location;
receiving a list of devices associated with the location from the second server;
using the list of devices to generate user interfaces to receive values of physical items associated with each of the devices.

16. The method of claim 15 wherein using the list of devices to generate user interfaces comprises:
filtering devices from the list of devices that have been designated to appear in a first user interface to produce a list of remaining devices; and
using the list of remaining devices to populate a menu for a second user interface.

17. The method of claim 16 wherein the first user interface comprises a list of the devices designated to appear in the first user interface together with a value of physical items associated with each of the devise designated to appear in the first user interface.

18. The method of claim 17 wherein the second user interface comprises a set of input fields for receiving values for each of a plurality of different physical items associated with a device selected using the menu.

19. The method of claim 17 wherein the value of physical items associated with a device is determined by physical counting objects.

20. The method of claim 15 wherein the second server receives transaction data from the devices in the list of devices.
